(19) United States
(12) Patent Application Publication
(10) Pub. No.: US 2016/0196929 A1
(43) Pub. Date: Jul. 7, 2016

(54) A MULTICOMPONENT APPROACH TO ENHANCE STABILITY AND CAPACITANCE IN POLYMER-HYBRID SUPERCAPACITORS

(71) Applicants: THE REGENTS OF THE UNIVERSITY OF CALIFORNIA, Oakland, CA (US); BIOSOLAR, INC., Santa Clarita, CA (US)

(72) Inventors: David VONLANTHEN, Santa Barbara, CA (US); Fred WUDL, Santa Barbara, CA (US); Alan J. HEEGER, Santa Barbara, CA (US); Pavel LAZAREV, South San Francisco, CA (US)

(73) Assignee: THE REGENTS OF THE UNIVERSITY OF CALIFORNIA, Oakland, CA (US)

(21) Appl. No.: 14/912,034

(22) PCT Filed: Aug. 15, 2014
(86) PCT No.: PCT/US2014/051330

§ 371 Date: Feb. 12, 2016

(51) Int. Cl. H01G 11/30; H01G 11/52; H01G 11/60; H01G 11/86; H01G 11/62

(52) U.S. Cl. CPC H01G 11/30; H01G 11/86; H01G 11/62; H01G 11/60; H01G 11/52

(57) ABSTRACT

An electrochemical energy storage device includes a first polymer electrode and a second polymer electrode spaced apart from the first polymer electrode such that a space is reserved between the first and second polymer electrodes. The space reserved between the first and second polymer electrodes contains an electrolyte that comprises a quinone compound. The first and second polymer electrodes each consist essentially of acid-dopable polymers.

This application claims priority to U.S. Provisional Application No. 61/866,398 filed Aug. 15, 2013, the entire content of which is hereby incorporated by reference.

This invention was made with Government support of Grant No. DE-FG02-08ER46535, awarded by the Department of Energy, Office of Basic Energy Sciences. The U.S. Government has certain rights in this invention.

### BACKGROUND

1. Technical Field

The field of the currently claimed embodiments of this invention relates to electrochemical energy storage devices, and more particularly to electrochemical energy storage devices with enhanced stability and capacitance.

2. Discussion of Related Art

Supercapacitors (electrochemical capacitors) are energy storage devices that exhibit high power density discharging hundreds of times faster than batteries, as required for power and back up applications in vehicles, consumer electronics, and solar cells.^{[1]} While the current generation of commercially available “double-layer” supercapacitors uses carbon as electrodes,^{[2]} research has been going on in the last few decades to increase the energy density in carbon-based supercapacitors by surface functionalization of the electrodes with redox active polymers, transition metals, or small molecules.^{[1a, 3]}

Polymers are abundant, low-cost, and easily processable materials, making them a candidate for the next generation of light-weight, thin, flexible, transparent, and low-cost energy storage solutions.^{[1c, 4]}

Moreover, electro-active polymers exhibit high intrinsic electric conductivity,^{[5]} large surface area,^{[6]} and cascades of quickly accessible redox states,^{[1a]} which makes them superior high-energy density electrode materials for supercapacitors. However, the low electrochemical cycling stability of electro-active polymers remains a serious problem that has hampered the development of stable polymer-based supercapacitor and battery devices.^{[3b, 7]} Thus, there remains a need for improved electrochemical energy storage devices with enhanced stability and capacitance.

### SUMMARY

According to some embodiments of the present invention, an electrochemical energy storage device includes a first polymer electrode and a second polymer electrode spaced apart from the first polymer electrode such that a space is reserved between the first and second polymer electrodes. The space reserved between the first and second polymer electrodes contains an electrolyte that comprises a quinone compound. The first and second polymer electrodes each consist essentially of acid-dopable polymers.

According to some embodiments of the present invention, a method for producing an electrochemical energy storage device includes forming a first polymer electrode comprising a first acid-dopable polymer material; depositing a spacer layer on the first polymer electrode; soaking the spacer layer in an electrolyte; and forming a second polymer electrode comprising a second acid-dopable polymer material over the spacer layer. The electrolyte comprises a quinone compound.

### BRIEF DESCRIPTION OF THE DRAWINGS

Further objectives and advantages will become apparent from a consideration of the description, drawings, and examples.

FIG. 1 is an illustration of an electrochemical energy storage device according to an embodiment of the current invention;

FIG. 2 is a schematic representation of a quinhydrone (BQHQ) polymer supercapacitor device structure and the involved charge transfer reactions during charge/discharge according to an embodiment of the current invention;

FIG. 3A shows capacity retention (%) versus number of cycles for a polymer supercapacitor (12.5 mA/cm²) in BQHQ/H₂SO₄/AcOH (curve 300) and in H₂SO₄/AcOH (curve 302);

FIG. 3B shows capacity retention (%) versus number of cycles for a polymer supercapacitor (12.5 mA/cm²) in BQHQ/H₂SO₄/AcOH;

FIG. 4A shows impedance Nyquist plots before and after 20,000 life cycles for a polymer supercapacitor in BQHQ/H₂SO₄/AcOH;

FIG. 4B shows impedance Nyquist plots before and after 20,000 life cycles for a polymer supercapacitor in H₂SO₄/AcOH;

FIG. 5 shows capacitance retention in the supercapacitor during long term cycling (12.5 mA/cm²) with HQ (73 mM, curve 500) and BQ (73 mM, curve 502) as the electrolyte and H₂SO₄/AcOH as the supporting electrolyte;

FIG. 6 shows long term cycling behavior of the polymer supercapacitor in BQHQ/H₂SO₄/AcOH during repetitive charge-discharge operations (1100) followed by open circuit periods (10);

FIG. 7 shows specific capacitance versus current density in BQHQ (◯, □) and without BQHQ (Δ) in H₂SO₄/AcOH as the supporting electrolyte;

FIG. 8 shows charge-discharge curves of a polymer supercapacitor in a BQHQ solution (curve 802) and in a supporting electrolyte (curve 800) at a current density of 1 mA/cm²; and

FIG. 9 shows a cyclic voltammogram of a polymer supercapacitor at 25 mVs¹ in BQHQ (73 mM, 1:1)/H₂SO₄/AcOH (curve 900) and in H₂SO₄/AcOH (curve 902), and of a supercapacitor at 25 mVs ¹ in BQHQ (73 mM, 1:1)/H₂SO₄/AcOH with solely current collectors without polyaniline (curve 904).

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

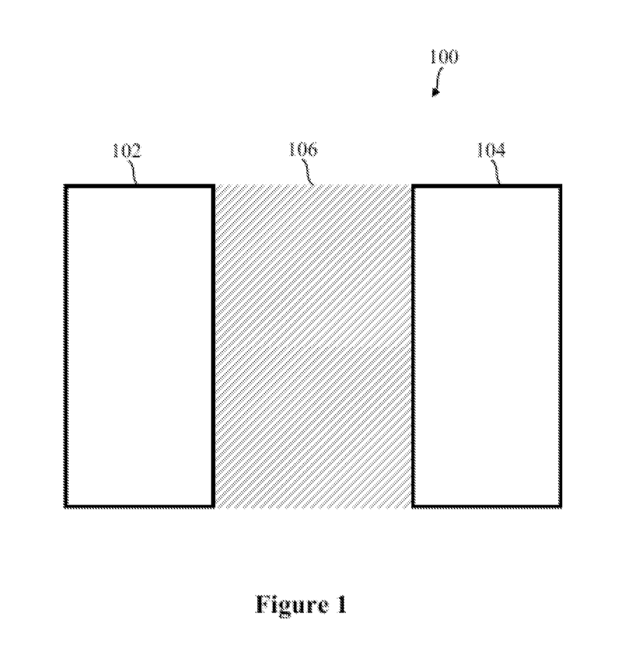

FIG. 1 is a schematic illustration of an electrochemical energy storage device 100 according to an embodiment of the current invention. The electrochemical energy storage device 100 includes a first polymer electrode 102, a second polymer electrode 104 spaced apart from the first polymer electrode with a space reserved there between, and an electrolyte 106 contained within the space reserved between the first and second polymer electrodes 102, 104. The electrolyte 106 includes a quinone compound, and the first and second polymer electrodes 102, 104 each consist essentially of acid-dopable polymers.

A multicomponent prototype polymer hybrid supercapacitor according to an embodiment of the current invention with outstanding cycling stability, high specific capacitance (Cₛ), and high energy density is now described. The broad concepts of the current invention are not limited to only this embodiment. The novel, multi-component approach according to this embodiment of the current invention combines two co-operative redox systems: polyaniline as the principal electro-active electrode, and a benzoquinone-hydroquinone (BQHQ) redox couple as electrolyte in the liquid phase of the device. Introduction of the second redox species in the supercapacitor creates a tunable redox shuttle that controls electron transfer processes at the porous polyaniline cast on the current collectors.

This universal strategy to store energy and increase the lifetime of a hybrid polymer-based supercapacitor by coupling redox chemistries of the polymeric electrodes and quinoid electrolytes in the liquid system of the hybrid-supercapacitor has not been previously reported. Publications in the field often report specific values for single electrodes measured in conventional three-electrode setups. All results presented here were obtained from real two-electrode supercapacitor devices.^{[8]}

Charge transfer between the polymer and quinhydrone is highly pH dependent and involves a fast, reversible, and complete two-electron transfer process at low pH.^{[13]} In other words, the family of quinone compounds is highly compatible with the entire family of acid-dopable metallic polymers, giving the opportunity for numerous new polymer-quinone couples to store energy in pseudocapacitive supercapacitors. In contrast, electrocatalysis of the quinone family at carbon,^{[3a, 14]} gold,^{[15]} and platinum^{[13a, 16]} electrodes is reported to be incomplete as irreversible adsorption processes of insulating molecules at the electrode surfaces take place. This highlights the great advantage of the polymer-electrode interface rendering heterogeneous electron-transfer in supercapacitors.

The greatly enhanced stability can be attributed to the efficient charge-transfer process between polyaniline and the quinoid system in solution, which substantially reduces the extent of the particular redox processes that are responsible for polymer decomposition.^{[7b, 17]}

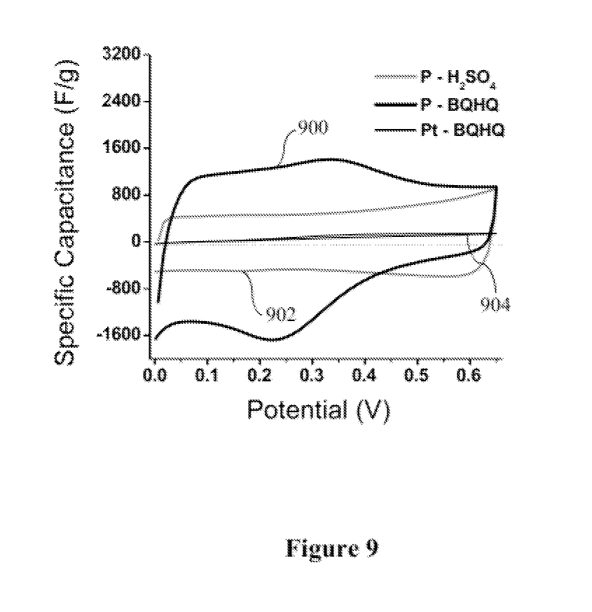

Polymers such as polyaniline cast on current collectors may also be referred to as polymer-modified electrodes. Depending on the thickness of the polymer film, the quinone redox-processes can occur at the outer or inner phase of the porous polymers or between the polymer and the metal substrate.^{[13]} Thus, charge transfer of the quinones in solution can also occur between the conductive polymer and the surface of the current collectors in the supercapacitors. However, quinone electrolytes (also referred to as modifiers) in combination with substrates without polymers give no capacitance (see FIG. 9, curve 904, described below). Both the quinone redox processes and the redox processes of the porous polymer contribute to the high capacitance.

Thus, a universal strategy for hybrid-polymer supercapacitors with enhanced stability is demonstrated. The approach to storing energy employs a porous polymer cast on current collectors to promote efficient electron transfer to a redox-active redox species in solution. After 50,000 charge-discharge cycles, no loss of specific capacitance was observed. The specific capacitance values Cₛ were significantly increased in all supercapacitors with the multi-component approach, while a high specific cell energy density of 7.7 Wh/kg was maintained. Utilizing the compatibility of the quinone redox chemistries at low pH with protonic acid-doped metallic polymers is a new and valuable strategy for tailoring polymer supercapacitors and polymer-containing hybrid supercapacitors and batteries to enhance stability, capacitance, and energy density.

A polymer-hybrid-supercapacitor according to some embodiments of the current invention may include the following elements:
A substrate support; for example, but not limited to, a platinum film;
A metallic polymer that is stable at low pH; e.g., but not limited to, polyaniline; and
A BQHQ (73 mM, 1:1) solution which was freshly prepared by dissolving BQ and HQ in a low-pH solution of aqueous H₂SO₄ (1 M) with AcOH (30%) to dissolve the formed quinhydrone complex.

A doped polymer suspension was sonicated for 45 minutes and drop cast on mass-fabricated Pt-substrate supports with dimensions of 200 nm×1 cm² for use as current collectors. Other acid resistant metallic substrates may be used as supports, including gold, stainless steel, a low or high alloy steel, silver, aluminum, titanium, tungsten, chromium, nickel, molybdenum, hastelloy, or a durimet alloy. In an embodiment of the invention, the metallic polymer is completely free of carbon material.

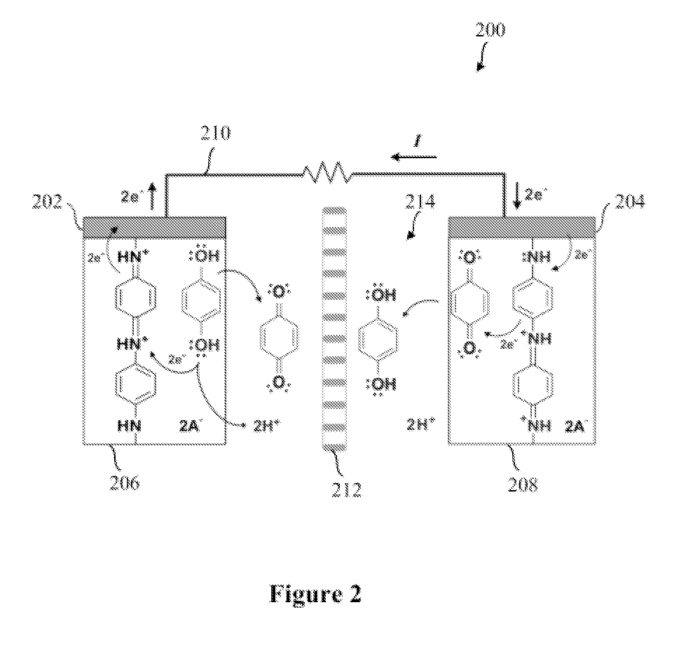

FIG. 2 shows a polymer-hybrid-supercapacitor 200 according to some embodiments of the current invention. In FIG. 2, the substrate supports 202, 204 were used as the contact to the metallic polymer 206, 208 and were connected to the external circuit 210. Metallic conjugated polymers of use include, but are not limited to, polyanilines, polythiophenes, e.g. PEDOT, polypyrroles, poly(aminonaphthalenes), poly(aminoanthracenes), poly(3-alkylthiophenes), poly(aminonaphthoquinones), poly(isothianaphthenes), poly(diphenylamines), and poly(diphenylamine-co-anilines). The metallic polymers may also be self-doped with organic protonic acids such as sulfonic acids in sulfonated polyaniline (S-PANI).

Examples of the supercapacitor devices were fabricated using two identical polymer electrodes. However, the general concepts of the current invention are not limited to two identical polymer electrodes. In some embodiments of the current invention, the polymer electrodes 206, 208 were separated by a spacer medium 212 soaked with the electrolyte solution 214. The spacer medium may be a porous solid such as a porous glass filter or polymer or other semi-permeable membrane. The polymer may be a proton exchange membrane or a molecule- or ion-selective membrane. Additional possible semi-permeable membranes include filter paper, a cellulose or cotton based filter. The electrolyte solution may comprise at least one of the following quinone compounds: hydroquinone, benzoquinone, naphthoquinone, anthraquinone, naphthacenequinone, pentacenequinone, or a mixture thereof.

In some embodiments the electrolyte solution may comprise a mixture of benzoquinone and hydroquinone. The benzoquinone and hydroquinone may be in a molecular ratio of from 1:9 to 9:1; for example, in a molecular ration of 1:1 (one-to-one). The quinone compound may contain at least one solubilizing group, such as at least one solubilizing sulfonic acid group, and/or at least one solubilizing hydroxyl group. In some embodiments, the electrolyte solution may include one or two quinone compounds with a molecular weight less than 600 g/mol. The electrolyte may include the quinone compound in a solution having a pH of less than 4, or of less than 2. The electrolyte solution may comprise the quinone compound in a low-pH solution such as sulfuric acid, hydrochloric acid, phosphoric acid, acetic acid, formic acid, methanesulfonic acid, or trifluoromethane sulfonic acid, or mixtures thereof.

The BQHQ solution undergoes reversible redox reactions within the low pH window where the metallic polymers are stable. The metallic polymer 206, 208 drop cast on the conductive substrate supports 202, 204 transfer charges to the BQHQ solution 214, as shown in FIG. 2. Conjugated polymers that are stable in the metallic state at low pH may be used, for example, but not limited to, polyaniline.

Further additional concepts and embodiments of the current invention will be described by way of the following examples. However, the broad concepts of the current invention are not limited to these particular examples.

### EXAMPLES

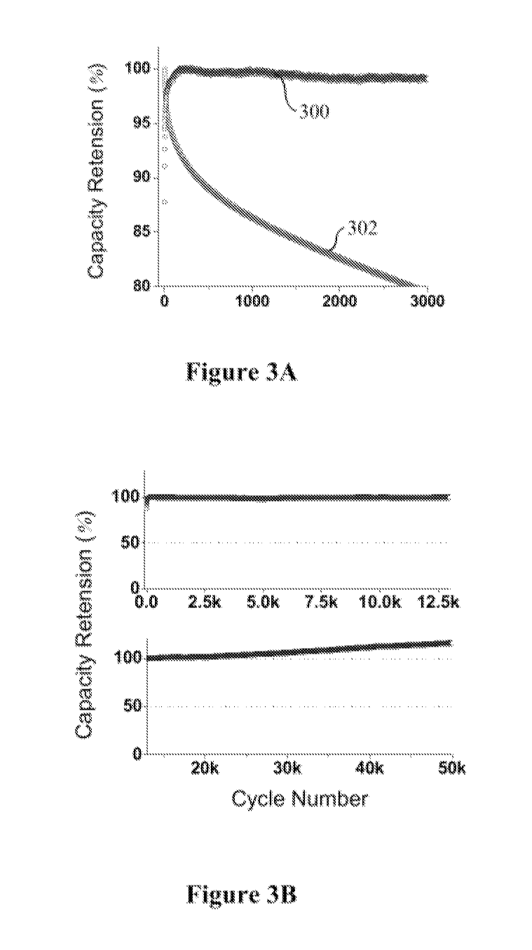

The polymer hybrid supercapacitors were prepared as follows. The polymer electrodes were prepared by suspending a commercially available emeraldine base (M=50,000) in a solution of water/DMSO, 1:1 (50 mg/mL in 1 M H₂SO₄). The doped polymer suspension was sonicated for 45 minutes and drop cast on mass-fabricated Pt substrates having dimensions of 200 nm×1 cm², which were used as current collectors. The films were then dried at 40° C. for one hour and at room temperature for six hours in the presence of air. No carbon material was used to alter the surface properties of the polymer. The BQHQ (73 mM, 1:1) solution was freshly prepared by dissolving BQ and HQ in a solution of aqueous H₂SO₄(1M) with AcOH (30%) to dissolve the formed quinhydrone complex. The supercapacitor devices were fabricated by using two identical polymer electrodes. They were separated by a glass filter soaked with electrolyte solution. Prior to long-cycling tests, the supercapacitor devices were preconditioned by asymmetric charge-discharge cycles at constant current (2.5 mA/cm², 15×±0.65 V) in the BQHQ electrolyte solution. All Cₛ values correspond to the point at steady state (see FIG. 3A and description below). The electrochemical cell behavior of the two-cell supercapacitors were studied using a Bio-Logic VMP3 potentiostat.

The addition of BQHQ electrolytes greatly enhanced the cycling stability of the supercapacitors with polymeric electrodes (PE). The advantage of the new approach over conventional polymer supercapacitors is evident from cycling experiments. FIG. 3B shows capacity retention (%) versus number of cycles for polymer supercapacitors with different electrolytes (12.5 mA/cm²). The polymer supercapacitor in the presence of solely a supporting electrolyte, H₂SO₄/AcOH, revealed a rapid loss of 10% capacitance after 350 cycles and dropped to 80% after 2800 cycles (curve 302). In contrast, the polymer supercapacitor in the presence of the quinoid electrolytes BQHQ/H₂SO₄/AcOH (curve 300) maintained cyclic stability, as further demonstrated in FIG. 3B.

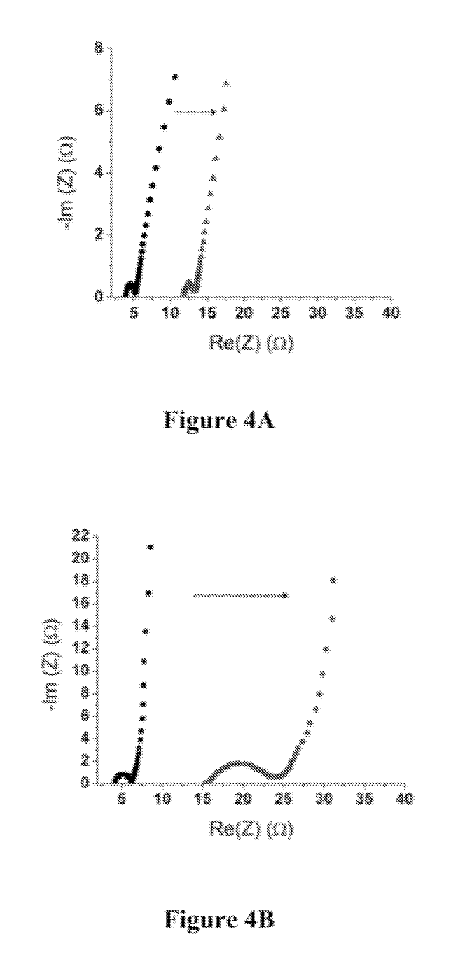

The long-term cycling displayed in FIG. 3B illustrates the outstanding cycling stability; over 50,000 cycles. After the first 13,000 cycles (upper graph), capacitance retention of 98% was observed. At longer times (lower graph), a continuous increase of 15% of the capacitance is observed. This again demonstrates the persistent stability of the polymeric electrodes in the presence of the quinoid electrolyte. AC-impedance measurements further support these findings. FIG. 4A shows impedance Nyquist plots before (circles) and after (triangles) 20,000 lift cycles for a polymer supercapacitor in the presence of BQHQ/H₂SO₄/AcOH. FIG. 4B shows impedance Nyquist plots before (squares) and after (circles) 20,000 galvanostatic cycles for a polymer supercapacitor in the presence of H₂SO₄/AcOH. The equivalent series resistance as well as the total resistance of the supercapacitors remained lower in the presence of BQHQ during long-term cycling. The observed increase in capacitance after long-term cycling shown in FIG. 3B can be explained by the formation of a concentration gradient of quinones and the less soluble quinhydrone complex^{[9]} at the solid polymer/liquid interface. These observed stability characteristics exceed by far those of polymer-carbon hybrid supercapacitors^{[4a, 4c, 4d]} and carbon-HQ-based supercapacitors.^{[3a]}

By adding the redox electrolytes we note an initial increase in capacitance reaching 95% after 7 cycles and 100% of the maximum capacitance after 300 cycles (FIG. 3A, curve 300). This feature indicates the presence of a complex equilibration/intercalation process at the porous polymer electrodes involving both the reductive hydroquinone and the oxidative benzoquinone molecules.

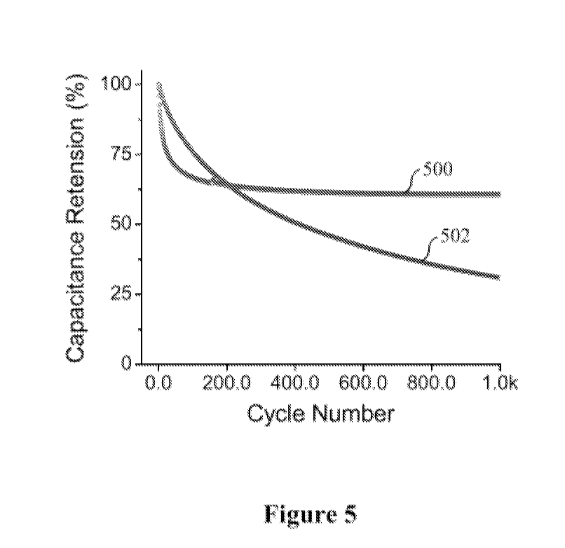

FIG. 5 shows capacitance retention in the supercapacitor during long term cycling (12.5 mA/cm²) with HQ (73 mM, curve 500) and BQ (73 mM, curve 502) as the electrolyte and H₂SO₄/AcOH as the supporting electrolyte. As shown in FIG. 5, the turn-on characteristics as well as the capacitance retention depend on the composition of the quinoid electrolytes, demonstrating the excellent tunability of the multi-component approach.

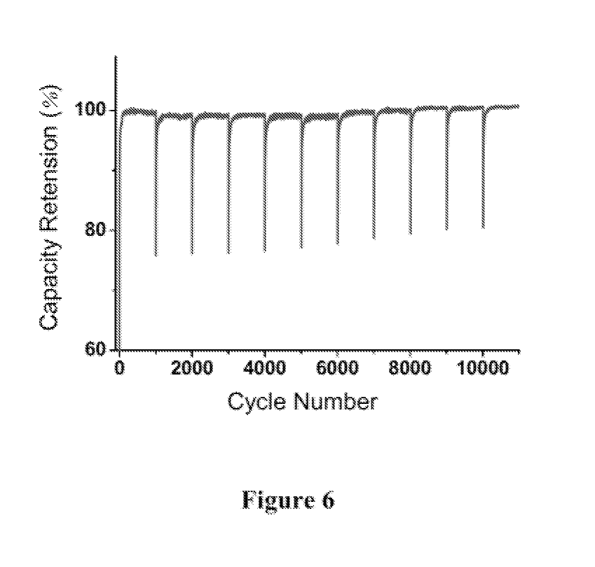

As shown in FIG. 6, repetitive charge-discharge operations (1100) followed by open circuit periods (10) in a polymer supercapacitor in the presence of BQHQ/H₂SO₄/AcOH showed no reduction of the charge storage capability over a total of 11,000 cycles. This result is of clear importance for practical applications. Similar stability behavior was observed for all supercapacitors investigated.

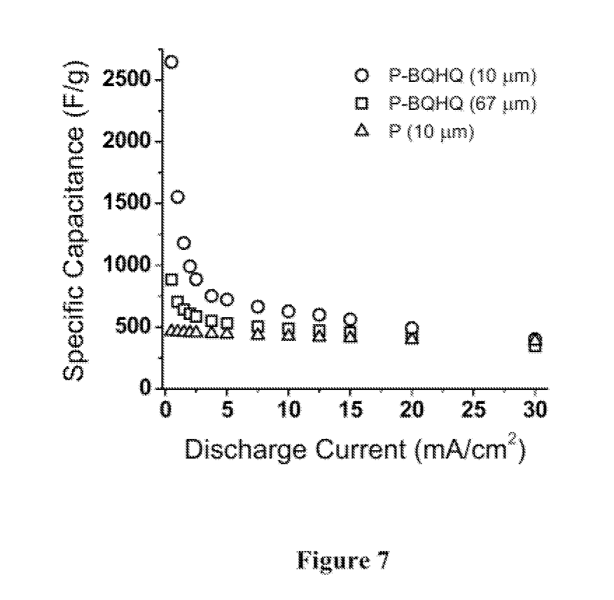

The specific capacitance (Cₛ, stored charge per electrode mass unit) increased in all supercapacitor devices in the presence of BQHQ electrolytes. As shown in FIG. 7, when polymer-electrodes (˜10 μm) were utilized, the Cₛ value increased by a factor of 5.5 compared to the pristine polymer devices (P) reaching a specific capacitance of 2646 F/g at the lowest measured current density (0.5 mA/cm²). In the case of the thicker polymer film (˜67 μm), the Cₛ values in the P-BQHQ supercapacitor almost doubled (882 F/g). Relatively high Cₛ values were noted for the pristine polymer supercapacitor which is attributed to the sub-mm electrode films and the employed counter ion-free emeraldine base. However, tremendous effort is going on to implement multi-micron polymer films into thinner, transparent, flexible, and printable energy-storage devices such as polymer- and carbon-polymer hybrid-supercapacitors.^{[4a, 4c, 7a]}

The increase in capacitance and stability is intrinsic to the multi-component approach. This is also in agreement with Cₛ values reported for polyaniline supercapacitors with similar device parameters.^{[10]} Furthermore, the high Cₛ values obtained cannot be explained by the intrinsic pseudo-capacitance of polyaniline.^{[1a, 11]}

FIG. 7 shows specific capacitance, Cₛ, versus current density in BQHQ (◯, □) and without BQHQ (Δ) with H₂SO₄/AcOH as the supporting electrolyte. During discharge, a drop of the Cₛ values was observed when the current density exceeded a value of 2 mA/cm². This point of transition is related to the diffusion of the quinones. At low current densities the transport of the relatively large quinoid molecules is not a problem. This feature is absent in the case of the pristine polymer supercapacitor, pointing to the different charge storage mechanism.

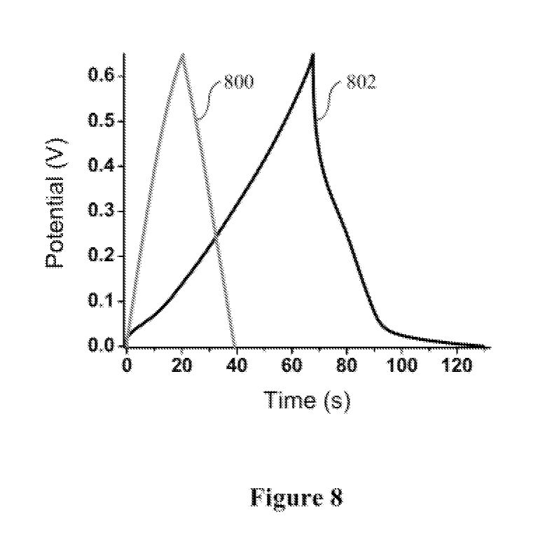

FIG. 8 displays the charge-discharge curves of supercapacitors with low-diffusion electrodes. The supercapacitor in H₂SO₄/AcOH (curve 800) exhibits a symmetric triangular-shape at constant current pointing to the linear voltage-time relation typically observed in electrochemical capacitors.^{[12]} However, in the multi-component supercapacitor, the charge-discharge curve 802 exhibits different slopes of voltage versus time indicating non-capacitive behavior. The introduction of the additional redox species divides the discharge profile of the supercapacitor into a high power regime at higher voltage and a more battery-like regime at lower voltage. This point of transition is related to the electrochemical potential of the redox active electrolyte and expresses the presence of the extra degree of freedom in this multicomponent hybrid approach.

The effect of the incorporation of the redox-active electrolytes is also evident in cyclic voltammograms, where the capacitance is a function of the voltage sweep rate. FIG. 9 shows a cyclic voltammogram of the polymer supercapacitor at 25 mVs⁻¹ in BQHQ (73 mM, 1:1)/H₂SO₄/AcOH (curve 900) and in H₂SO₄/AcOH (curve 902). In the presence of the BQHQ electrolytes (curve 900) additional redox features between 0 V and 0.4 V appeared which can be attributed to redox processes of the quinones. A characteristic rectangular shape was observed for the pristine polymer supercapacitor (curve 902).^{[1a}] BQHQ (73 mM, 1:1)/H₂SO₄/AcOH (curve 904) with solely current collectors (without polyaniline) gives no capacitance.

In the presence of the quinoid electrolytes (curve 900 in FIG. 9), an asymmetric behavior is observed with a high specific capacitance at low potential and a reduced capacitance at higher potential during discharge (←). These different capacities can be explained by the continuous electron-transfer process from the metallic emeraldine state of polyaniline to the BQHQ redox couple in solution. However, the overall measured Cₛ values of the PE-BQHQ hybrid supercapacitors are greatly improved compared to the pristine device, and the high specific energy density of 7.7 Wh/kg was maintained at the operating voltage of 0.65V.

The excellent interplay between the quinhydrone (BQHQ) redox pair and polyaniline that results in increasing the specific capacitance, Cₛ, in the supercapacitors is illustrated in FIG. 2.

In conclusion, examples of a universal strategy for hybrid-polymer supercapacitors with enhanced stability were demonstrated. The approach to store energy employs a porous polymer as electrode to promote efficient electron transfer to a redox-active redox-species in solution. After 50,000 charge-discharge cycles, no loss of specific capacitance was observed. The specific capacitance values Cₛ were significantly increased in all supercapacitors with the multi-component approach while a high specific cell energy density of 7.7 Wh/kg was maintained. The compatibility of the quinone redox chemistries at low pH with protonic acid-doped metallic polymers is a new and valuable strategy for tailoring polymer supercapacitors and polymer-containing hybrid supercapacitors and batteries to enhance stability, capacitance, and energy density.

### REFERENCES

[1] a) G. A. Snook, P. Kao, A. S. Best, J. Power Sources 2011, 196, 1-12; b) J. R. Miller, P. Simon, Science 2008, 321, 651-652; c) H. Li, Q. Zhao, W. Wang, H. Dong, D. Xu, G. Zou, H. Duan, D. Yu, Nano Lett. 2013, 13, 1271-1277.
[2] L. L. Zhang, X. S. Zhao, Chem. Soc. Rev. 2009, 38, 2520-2531.
[3] a) S. Roldán, C. Blanco, M. Granda, R. Menéndez, R. Santamaría, Angew. Chem. Int. Ed. 2011, 50, 1699-1701; b) P. Simon, Y. Gogotsi, Nat. Mater. 2008, 7, 845-854; c) G. Wang, L. Zhang, J. Zhang, Chem. Soc. Rev. 2012, 41, 797-828.
[4] a) H. Lin, L. Li, J. Ren, Z. Cai, L. Qiu, Z. Yang, H. Peng, Sci. Rep. 2013, 3; b) L. Yuan, X. Xiao, T. Ding, J. Zhong, X. Zhang, Y. Shen, B. Hu, Y. Huang, J. Zhou, Z. L. Wang, Angew. Chem. Int. Ed. 2012, 51, 4934-4938; c) Q. Wu, Y. Xu, Z. Yao, A. Liu, G. Shi, ACS Nano 2010, 4, 1963-1970; d) C. Meng, C. Liu, L. Chen, C. Hu, S. Fan, Nano Lett. 2010, 10, 4025-4031.
[5] A. J. Heeger, Angew. Chem. Int. Ed. 2001, 40, 2591-2611.
[6] J. Huang, R. B. Kaner, J. Am. Chem. Soc 2004, 126, 851-855.
[7] a) L. Nyholm, G. Nyström, A. Mihranyan, M. Strømme, Adv. Mater. 2011, 23, 3751-3769; b) R. Kötz, M. Carlen, Electrochimica Acta 2000, 45, 2483-2498.
[8] M. D. Stoller, R. S. Ruoff, Energy Environ. Sci. 2010, 3, 1294-1301.
[9] R. E. Moser, H. G. Cassidy, J. Am. Chem. Soc 1965, 87, 3463-3467.
[10] a) H. Zhou, H. Chen, S. Luo, G. Lu, W. Wei, Y. Kuang, J. Solid State Electrochem. 2005, 9, 574-580; b) C. Meng, C. Liu, S. Fan, Electrochem. Comm. 2009, 11, 186-189.
[11] C. Peng, D. Hu, G. Z. Chen, Chem. Comm. 2011, 47, 4105-4107.
[12] V. Khomenko, E. Frackowiak, F. Béguin, Electrochim. Acta 2005, 50, 2499-2506.
[13] a) J. C. Cooper, E. A. H. Hall, Electroanalysis 1993, 5, 385-397; b) Z. Mandić, L. Duić, J. Electroanal. Chem. 1996, 403, 133-141; c) A. Malinauskas, R. Holze, Electrochim. Acta 1998, 43, 2563-2575.
[14] S. H. DuVall, R. L. McCreery, Anal. Chem. 1999, 71, 4594-4602.
[15] V. Budavári, Á. Sz [symbol] cs, A. Oszkó, M. Novák, Electrochim. Acta 2003, 48, 3499-3508.
[16] E. Laviron, J. Electroanal. Chem. Interfacial Electrochem. 1984, 164, 213-227.
[17] E. Frackowiak, V. Khomenko, K. Jurewicz, K. Lota, F. Béguin, J. Power Sources 2006, 153, 413-418.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. An electrochemical energy storage device, comprising:
a first polymer electrode;
a second polymer electrode spaced apart from said first polymer electrode with a spaced reserved there between; and
an electrolyte contained within said space reserved between said first and second polymer electrodes,
wherein said electrolyte comprises a quinone compound, and
wherein said first and second polymer electrodes each consist essentially of acid-dopable polymers.

2. An electrochemical energy storage device according to claim 1, wherein said electrolyte comprises benzoquinone and hydroquinone.

3. An electrochemical energy storage device according to claim 2, wherein said electrolyte comprises benzoquinone and hydroquinone in molecular ratio of 1:9 to 9:1.

4. An electrochemical energy storage device according to claim 2, wherein said electrolyte comprises benzoquinone and hydroquinone in molecular ratio of one-to-one.

5. An electrochemical energy storage device according to claim 1, wherein said electrolyte contains at least one of the following quinone compounds:hydroquinone, benzoquinone, naphthoquinone, anthraquinone, naphthacenequinone, and pentacenequinone.

6. An electrochemical energy storage device according to claim 5, wherein said quinone compound contains at least one solubilizing sulfonic acid group.

7. An electrochemical energy storage device according to claim 5, wherein said quinone compound contains at least one solubilizing hydroxyl group.

8. An electrochemical energy storage device according to claim 1, wherein said electrolyte comprises one or two quinone compounds with a molecular weight less than 600 g/mol.

9. An electrochemical energy storage device according to claim 1, wherein said electrolyte comprises said quinone compound in a solution having a pH less than 4.

10. An electrochemical energy storage device according to claim 1, wherein said electrolyte comprises said quinone compound in a solution having a pH less than 2.

11. An electrochemical energy storage device according to claim 10, wherein said solution having a pH less than 2 comprises at least one supporting electrolyte comprising at least one of sulfuric acid, hydrochloric acid, phosphoric acid, acetic acid, formic acid, methanesulfonic acid, and trifluoromethane sulfonic acid.

12. An electrochemical energy storage device according to claim 1, wherein said acid-dopable polymers of said first and second polymer electrodes comprise at least one of polyanilines, polythiophenes, polypyrroles, poly(aminonaphthalenes), poly(aminoanthracenes), poly(3-alkylthiophenes), poly(aminonaphthoquinones), poly(isothianaphthenes), poly(diphenylamines), and poly(diphenylamine-co-anilines).

13. An electrochemical energy storage device according to claim 1, wherein said first and second polymer electrodes each consist essentially of polyaniline.

14. An electrochemical energy storage device according to claim 1, wherein said first polymer electrode consists essentially of a first polymer and said second polymer electrode consists essentially of a second polymer, and wherein said first polymer is different from said second polymer.

15. An electrochemical energy storage device according to claim 1, further comprising a spacer medium located between said first polymer electrode and said second polymer electrode to assist with maintaining said space there between, wherein said spacer medium contains said electrolyte absorbed therein.

16. An electrochemical energy storage device according to claim 15, wherein said spacer medium is a porous solid.

17. An electrochemical energy storage device according to claim 16, wherein said porous solid is at least one of a porous glass filter or a polymer.

18. An electrochemical energy storage device according to claim 17, wherein said polymer is a proton exchange membrane or a molecule- or ion-selective membrane.

19. An electrochemical energy storage device according to claim 15, wherein said spacer medium is a gel.

20. An electrochemical energy storage device according to claim 15, wherein said spacer medium is filter paper.

21. An electrochemical energy storage device according to claim 15, wherein said spacer medium is a cellulose or cotton based filter.

22. An electrochemical energy storage device according to claim 1, further comprising a substrate, wherein said first polymer electrode is formed on said substrate.

23. An electrochemical energy storage device according to claim 1, further comprising a current collector that is an acid resistant metallic substrate.

24. An electrochemical energy storage device according to claim 23, wherein said acid resistant metallic substrate is one of platinum or gold.

25. An electrochemical energy storage device according to claim 23, wherein said acid resistant metallic substrate is one of stainless steel or a low or a high alloy steel.

26. An electrochemical energy storage device according to claim 23, wherein said acid resistant metallic substrate is one of titanium, tungsten, aluminum, silver, chromium, nickel, or molybdenum.

27. An electrochemical energy storage device according to claim 23, wherein said acid resistant metallic substrate is one of hastelloy or a durimet alloy.

28. A method for producing an electrochemical energy storage device, comprising:
forming a first polymer electrode comprising a first acid-dopable polymer material;
depositing a spacer layer on said first polymer electrode;
soaking said spacer layer in an electrolyte; and
forming a second polymer electrode comprising a second acid-dopable polymer material over said spacer layer,
wherein said electrolyte comprises a quinone compound.

29. The method according to claim 28, wherein said electrolyte comprises benzoquinone and hydroquinone.

30. The method according to claim 28, wherein said electrolyte comprises said quinone compound in a solution having a pH less than 2.

31. The method according to claim 28, wherein said first and second acid-dopable polymer materials comprise at least one of polyanilines, polythiophenes, polypyrroles, poly(aminonaphthalenes), poly(aminoanthracenes), poly(3-alkylthiophenes), poly(aminonaphthoquinones), poly(isothianaphthenes), poly(diphenylamines), and poly(diphenylamine-co-anilines).

32. The method according to claim 28, further comprising providing a substrate upon which said first polymer electrode is formed,
wherein said substrate is an acid resistant metallic substrate.
